(19) United States
(12) Patent Application Publication
(10) Pub. No.: US 2011/0265059 A1
(43) Pub. Date: Oct. 27, 2011

(54) FRAMEWORK FOR MANAGEMENT SOFTWARE AND DEVELOPMENT SYSTEM THEREFOR

(76) Inventor: Jianjiang Zhou, Shaoxing (CN)

(21) Appl. No.: 13/176,733

(22) Filed: Jul. 5, 2011

Related U.S. Application Data
(63) Continuation of application No. PCT/CN2009/075200, filed on Nov. 29, 2009.

(30) Foreign Application Priority Data
Jan. 10, 2009 (CN) 200910095613.7

(51) Int. Cl. G06F 9/44

(52) U.S. Cl. 717/102

(57) ABSTRACT

A framework for management software, including a file module, an organization module, an interception module, and a line module. The file module includes a file, the file flowing in the line from generation, being operated in the interception module, collection, to filing. The content of the file belongs to the interception module and is submitted by keys which mean the rights of entering each interception. The interception module is the working environment of a job, comprising identification, net, task, enterprise, record and resources, content, plan, and organization. The file is generated and flows in the line by conversation with the interceptions. The line module comprises all steps from the generation of the file to filing, each step related to a key. The organization module comprises all the interceptions with the keys.

### CROSS-REFERENCE TO RELATED APPLICATIONS

This application is a continuation of International Patent Application No. PCT/CN2009/075200 with an international filing date of Nov. 29, 2009, designating the United States, now pending, and further claims priority benefits to Chinese Patent Application No. 200910095613.7 filed on Jan. 10, 2009. The contents of all of the aforementioned applications, including any intervening amendments thereto, are incorporated herein by reference.

### BACKGROUND OF THE INVENTION

1. Field of the Invention

The invention relates to a framework for management software and a development system therefor.

2. Description of the Related Art

With fast expansion of modern organizations, requirement for management level thereof is increasingly increased, management thereof becomes intensive, competition of information and decision reflection capability becomes more and more fierce, and desire for software-assisted management becomes even higher. There are various kinds of management software on market. Disadvantages about these management software are summarized below: first, these software has not a uniform design rule, and after it is used, users have to input operation records into computers, which increases workload; as a small mistake occurs, the whole system is to break down and the data will not be corrected any more; moreover, working task and targets of the users cannot be supported by the system, and working responsibility and content of the users cannot be monitored and put into practice, and file establishment of organizations is not taken into adequate account.

### SUMMARY OF THE INVENTION

In view of the above-described problem, it is an objective of the invention to provide a framework for management software that is capable of collecting all type of authorized files and records covering various organizations.

It is another objective of the invention to provide a development system for a framework for management software that is capable of collecting all type of authorized files and records covering various organizations.

To achieve the above objectives, in accordance with one embodiment of the invention, provided is a framework for management software, comprising a file module, an organization module, an interception module, and a line module, wherein the file module comprises a file, the file flowing in the line from generation, being operated in the interception module, collection, to filing; the content of the file belongs to the interception module and is submitted by keys which mean the rights of entering each interception; the interception module is the working environment of a job, comprising identification, net, task, enterprise, record and resources, content, plan, and organization; the file is generated and flows in the line by conversation with the interceptions; the line module comprises all steps from the generation of the file to filing, each step related to a key; and the organization module comprises all the interceptions with the keys.

In accordance with another embodiment of the invention, provided is a software development system for a framework, comprising a database, interfaces, and procedures, wherein the database comprises a file table, an organization table, and an unlocking table; the interfaces comprise a system login form, a main form, a child form of an interception, a file child form, an unlocking form, and sub-task and keys on the child form; and the database is connected to the interfaces via the procedures.

In a class of this embodiment, the file table operates to build a plan file, to identify operation status of key procedures via recorded status thereof whereby functioning as a switch to activate an interception, and to build a file number as a key field, the key field comprising a step name, a plan time for the step, and a record time for the step, the plan time and the record time are parallel to each other and forms a loop; each time a new file is built, the circulation of the key field is used to control the implementation of tasks.

In a class of this embodiment, the organization table uses an organization number as a key field and collects organizations sharing different key procedures of the file table into the table, and the organization table authorizes a user to enter different child forms.

In a class of this embodiment, the file unlocking table uses a record number as a key field, whereby managing locking and unlocking of files; each authorized unlocking department obtains and processes the record to be unlocked according to keyword selection pertained thereto.

In a class of this embodiment, the system login form operates to authenticate a user, and to determine a department to which the user pertains whereby loading him to different child forms and enabling him to process different content therein.

In a class of this embodiment, the main form has a style of multiple document interface, with capacity of loading child forms, searching files, and comprising shift keys.

In a class of this embodiment, the child form is distributed and designed according to departments, each department having a child form called interception and each interception having keys for fields of steps; whether the contents of interception saved or not is decided by the status of the fields.

In a class of this embodiment, the unlocking form shows the applying record and operates to unlock a file.

In a class of this embodiment, the file child form operates to manage all files and status thereof, and to implement a fast inquiry of a file, control of file status, comprising unlocking and locking thereof, and reading of file content whereby creating, tracking and controlling the file, a file table being a table or a Gantt chart.

In a class of this embodiment, the sub-task area is disposed under each of the child form, displaying the status of files needing to process.

In a class of this embodiment, the procedure comprises:
1) a login procedure, operating to implement login of different users from different departments;
2) a procedure of switching interceptions under a main form, operating to implement switching between different keys and response to data export;
3) a procedure of searching files and reading under a main form, operating to implement data-reading procedures corresponding to different child forms;
4) a content inquiry procedure under a main form, operating to implement file retrieval for different keywords;
5) a file creation procedure under a file child form, operating to create a new file, and to make a new organization plan;
6) a file unlocking procedure under a file child form, operating to unlock a key procedure as the key procedure is locked;
7) a file freezing procedure under a file child form, operating to freeze a file as the file needs to be frozen;
8) a control key submission procedure under a child form, operating to implement locking of the key procedure via submission of the control key; and
9) an unlocking procedure, operating to lock a file via an authorized department having unlocking permission.

In a class of this embodiment, the locking in the control key submission procedure corresponds to the file unlocking procedure as well as the unlocking therein under the file child form.

In a class of this embodiment, the login procedure comprises: 1) searching for a login user, a password, and a workgroup in the organization table, 2) exiting if no result is found, and 3) opening the interception module of the workgroup if a result found.

In a class of this embodiment, the interception switching procedure comprises: 1) searching for a file in the file table, 2) determining content to be read from a database according to requirement of form content of the interception module, 3) determining an activated interception module according to the interception switching procedure under the main form, 4) determining whether the procedure is completed according to a field value of a key procedure in the file table, 5) deactivating a corresponding key if the procedure is completed, or activating the corresponding key if the procedure is not completed.

In a class of this embodiment, the content inquiry procedure of the child form under the main form comprises: 1) searching for a corresponding key field in the file table, and 2) displaying content of a file in the interception module of the file.

In a class of this embodiment, the unlocking procedure comprises: 1) finding an unlocking record that has been processed, 2) finding a file number and a value for a key procedure according to content of the unlocking record, and 3) processing the file table, whereby finding a file number and a field for a key procedure, and performing value recovery thereon.

Advantages of the invention are summarized below:
1) the invention logs in a job position of an organization via personal identification, and the job position is net, comprising the working task, the working plan, and the working content of the position, and is capable of meeting working requirements thereof;
2) since file establishment, signature and operation record are complete, the system analyzes signed content and makes decision, which further improves accuracy of a plan; working tasks and targets of users are supported by the system, working responsibility and content of the users are monitored and put into practice, and file establishment of the organization is improved, which increases enterprise management level and solves the problem that human and machines cannot be integrally managed;
3) the system of the invention can implement unified management, share resources, prevent repeated workload and work delay, and alleviate workload.

### BRIEF DESCRIPTION OF THE DRAWINGS

Further description will be given below in conjunction with accompanying drawings and specific embodiments:

FIG. 1 illustrates a framework for management software of an exemplary embodiment of the invention;

FIG. 2 illustrates interfaces for a software development system of the invention;

FIG. 3 illustrates a login procedure of a software development system of the invention;

FIG. 4 illustrates a content reading procedure of a child form under a main form of a software development system of the invention; and

FIG. 5 illustrates a content inquiry procedure of a child form under a main form of a software development system of the invention.

### DETAILED DESCRIPTION OF THE EMBODIMENTS

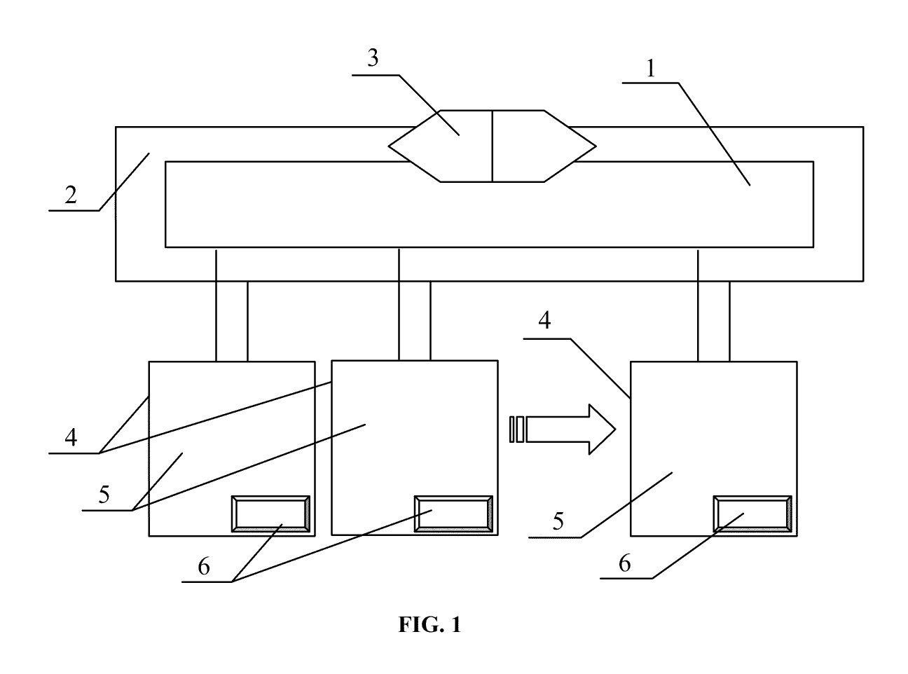

A framework for management software comprises a file module, an organization module, an interception module, and a line module. The file module comprises a file. The file flows in the line from generation, being operated in the interception module, collection, to filing. The content of the file belongs to the interception module and is submitted by keys which mean the rights of entering each interception. The interception module is the working environment of a job, comprising identification, net, task, enterprise, record and resources, content, plan, and organization. The file is generated and flows in the line by conversation with the interceptions. The line module comprises all steps from the generation of the file to filing, each step related to a key. The organization module comprises all the interceptions with the keys. As shown in FIG. 1, a framework for management software illustrates an organization 1, organization line for a key procedure 2, a file 3, an interception 4, content of the interception 5, a control key 6. Users log in a job position of an organization via personal identification, the job position is net, comprises the working task, the working plan, and the working content of the position.

A software development system for a framework comprises a database, interfaces, and procedures. The database comprises a file table, an organization table, and an unlocking table. The interfaces comprise a system login form, a main form, a child form of an interception, a file child form, an unlocking form, and sub-task and keys on the child form. The database is connected to the interface via the procedures.

The file table operates to build a plan file, to identify operation status of key procedures via recorded status thereof whereby functioning as a switch to activate an interception, and to build a file number as a key field, the key field comprising a step name, a plan time for the step, and a record time for the step, the plan time and the record time are parallel to each other and forms a loop; each time a new file is built, the circulation of the key field is used to control the implementation of tasks.

The organization table uses an organization number as a key field and collects organizations sharing different key procedures of the file table into the table, and the organization table authorizes a user to enter different child forms.

The file unlocking table uses a record number as a key field, whereby managing locking and unlocking of files; each authorized unlocking department obtains and processes the record to be unlocked according to keyword selection pertained thereto

The system login form operates to authenticate a user, and to determine a department to which the user pertains whereby loading him to different child forms and enabling him to process different content therein.

The main form has a style of multiple document interface, with capacity of loading child forms, searching files, and comprising shift keys.

The child form is distributed and designed according to departments, each department having a child form called interception and each interception having keys for fields of steps; whether the contents of interception saved or not is decided by the status of the fields.

The unlocking form shows the applying record and operates to unlock a file.

The file child form operates to manage all files and status thereof, and to implement a fast inquiry of a file, control of file status, comprising unlocking and locking thereof, and reading of file content whereby creating, tracking and controlling the file, a file table being a table or a Gantt chart.

The sub-task area is disposed under each of the child form, displaying the status of files needing to process.

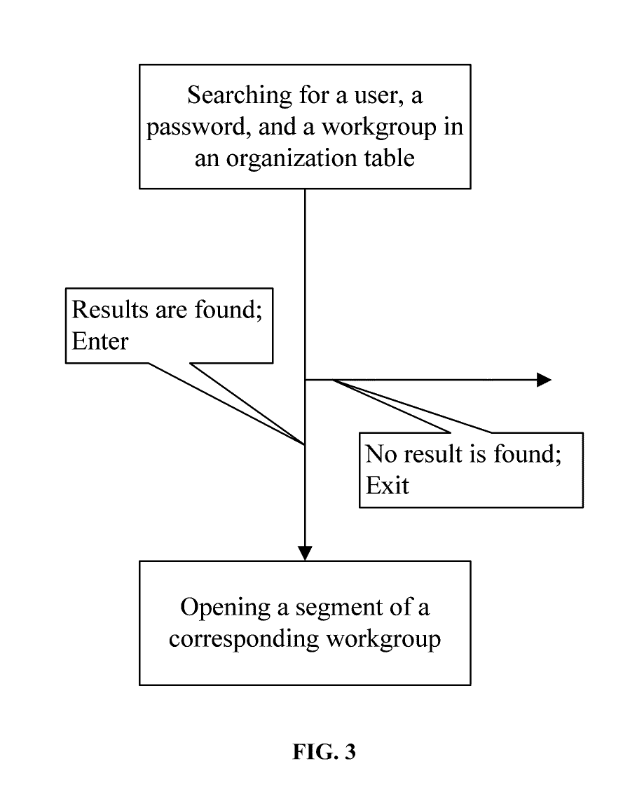

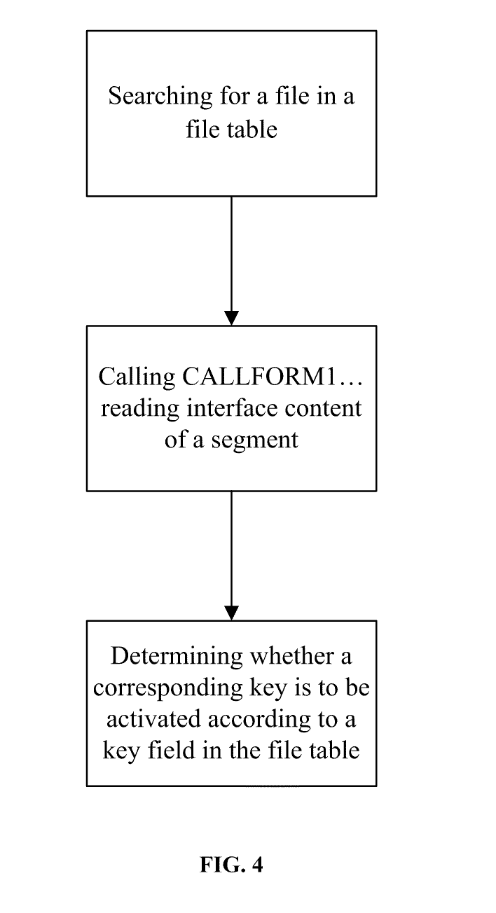

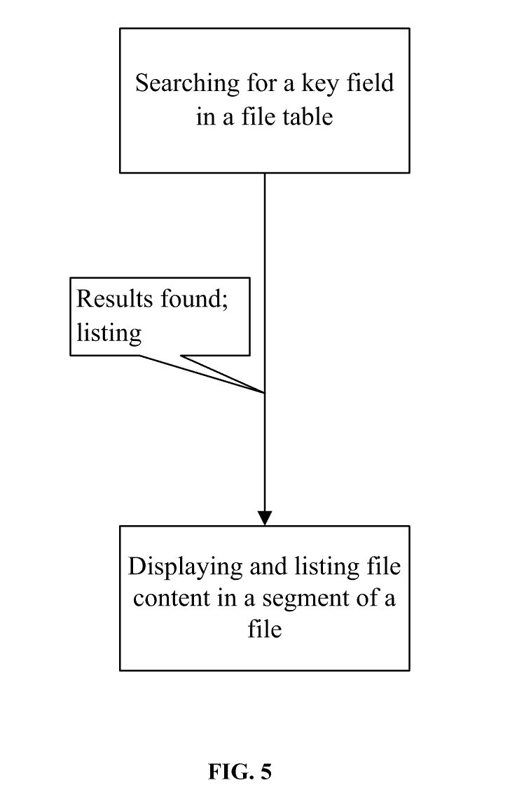

The procedures comprise:
1) a login procedure, as shown in FIG. 3, operating to implement login of different users from different departments and calls different child forms for interceptions according to different departments;
2) a procedure of switching interceptions under a main form, operating to implement switching between different keys and response to data export;
3) a procedure of searching files and reading under a main form, as shown in FIG. 4, operating to implement data-reading procedures according to different child forms;
4) a content inquiry procedure under a main form, as shown in FIG. 5, operating to implement file retrieval for different keywords;
5) a file creation procedure under a file child form, operating to create a new file, and to make a new organization plan;
6) a file unlocking procedure under a file child form, operating to unlock a key procedure locked;
7) a file freezing procedure under a file child form, operating to freeze a file needing to be frozen;
8) a control key submission procedure under a child form, operating to implement locking of the key procedure via submission of the control key; and
9) an unlocking procedure, operating to unlock a file by an authorized department having unlocking permission.

An objective of the procedure of switching interceptions under a main form is to implement switching between different child forms under the main form. The procedure is implemented via the following codes:

BEGIN
FORM1. SHOW;
END.

An objective of the procedure of searching files and reading under a main form is mainly to call content required by an activated child form of interceptions according to different file numbers. The procedure is implemented as follows:
a) establishing database content according to child form content of each interception comprising a job identification, a net, a task, an enterprise, a record and resource, a content, a plan, and an organization; logging in a job position of an organization by users via personal identification (the job position is net, comprises the working task, the working plan, and the working content of the position, different interceptions indicate different job position with different work content; the child forms of the interceptions are changeable, designed, and read in, and the read-in procedure is made into a procedure program (CALLFORM1 CALLFORM2 . . . );
b) determining an interception that is currently activated according to above procedure 2), or via the following program:

```
BEGIN
    IF FORM1, ACTIVE=TRUE THEN CALLFORM1;
    IF FORM2, ACTIVE=TRUE THEN CALLFORM2;
...
END;
```

c) determining whether the procedure is completed according to the field value thereof in the table (the key procedure corresponds to a key of the child form of the interception). The following procedure 8) implements changing of the field value of the key procedure in the table. Here whether the key procedure of the interception is completed is determined via the field value, if the procedure is completed, the key is not activated, otherwise the key is activated.

An objective of the content inquiry procedure under a main form is that: the file table in the framework collects information record of all files, and records key property of the files, if there are too many files, inquiry is necessary. A special child form to operate on the files may be a child form (interception) of the system. The procedure is implemented as follows:
a) searching for a corresponding key field in the table; and
b) displaying content of the file in the interception module of the file.

An objective of the file creation procedure under a file child form is mainly to create a file record, and adds data to the file table. The procedure is implemented as follows: according requirement for file fields, especially for fields containing the key procedure, time of each key procedure is added, which is implemented via a simple storage procedure, or an append.

An objective of the file unlocking procedure under a file child form is that: as a file applies for unlocking, if the key procedure is submitted in the following procedure 8), value of a key field in the table is changed, if it is impossible to submit the key procedure, or content of the interception does not meet requirement and needs to be revised, data are to be recovered, and unlocking application is to be submitted, at this time only values of fields of the key procedure in the file table need to be recovered, the file is read in (the above procedure 3), and a key corresponding to the interception is activated.

The procedure is implemented as follows: to add record and transmit content, such as workgroups, file numbers, key procedures, unlocking reasons, and so on therein, to the unlocking table, so that as authorized persons see the unlocking request, he finds a file number transmitted by the record via the following procedure 9), and recover field values of a key procedure of a corresponding file number in the file table.

An objective of the control key submission procedure under a child form is to show that submission of a key indicates the key procedure is completed. By detecting whether the key is in an activated status, it can be determined that whether content data under a child form of an interception can be revised and added to a database. The key ensures accuracy of data. If the key is submitted, the key is not active, and the field value of a corresponding key procedure in the file table is changed. As the above procedure 3) is called, the key is not activated, which means that it is impossible to change content of the interception. The procedure is implemented as follows: to operate on the file table, find a file number and a corresponding field, and change a value thereof.

Normally, prior to submission, it is possible to determine whether requirement for submission can be met according to requirement set by the interception, to inquire whether certain limitation is to be added, whereby preventing easy submission of the key.

An objective of the unlocking procedure is to unlock a file. After the procedure 6) transmits a file unlocking request, an authorized person receives the data, analyzes the record, and changes a field value in the table, whereby implementing unlocking. There is a precondition that the unlocking information is read under cooperation of another procedure. The procedure is implemented as follows: a cooperation procedure: all unlocking records that meet requirement, normally records that are not unlocked, are listed on the child form, and data records are found according to certain conditions:
a) finding unlocking records;
b) finding file numbers and values of key procedures according to content of the unlocking records; and
c) operating on the file table, whereby finding file numbers and fields of the key procedures, and recovering values thereof.

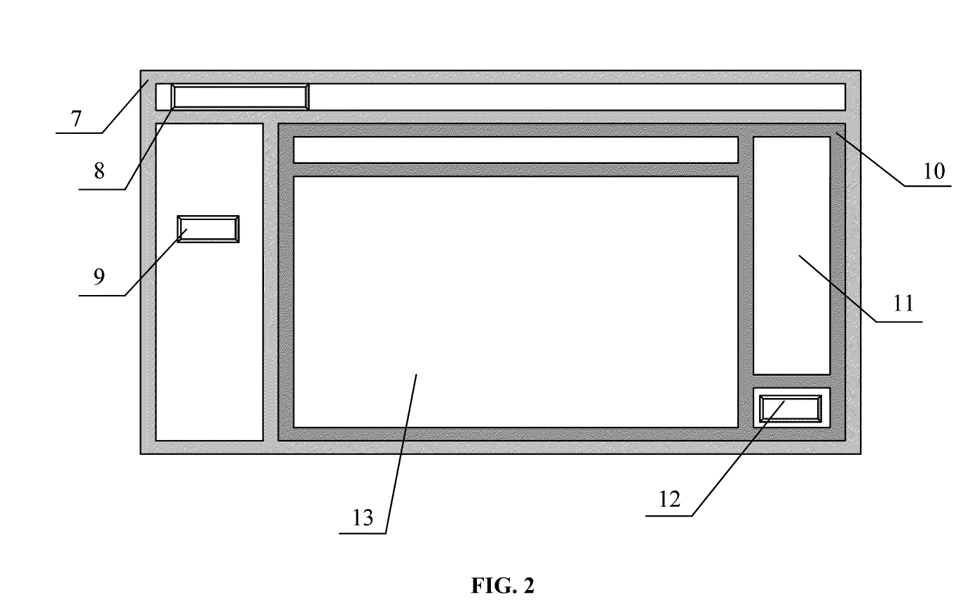

For the system of the invention, first the table is created, three or even N organizations are prepared, and ten or even N key procedures are set. In the organization table, the ten or N key procedures are allocated to the three or N organizations. Second, a login interface is created. Third, a main form, a file child form, and other child forms required by the organizations are created. If three organizations are used, three child forms required by the organizations are created. If N organizations are used, N child forms required by the organizations are created. As shown in FIG. 2, a parent interface 7, a switching key 8, procedure read-in 9, a child form 10, a plan display 11, a control key 12, and content distribution of the child form 13 are illustrated. Next, a login procedure is created, and all the above-mentioned procedures are created, so that entry to different workgroups or other child forms with different IDs is implemented, and file read-in content corresponds to that of the child forms. The control key can change field values of the key procedures in the file table, implement unlocking request, transmit file numbers, activate the unlocking program, and facilitate reverse operation of the control key.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A framework for management software, comprising
a file module;
an organization module;
an interception module; and
a line module;
wherein
the file module comprises a file, the file flowing in the line from generation, being operated in the interception module, collection, to filing;
the content of the file belongs to the interception module and is submitted by keys which mean the rights of entering each interception;
the interception module is the working environment of a job, comprising identification, net, task, enterprise, record and resources, content, plan, and organization;
the file is generated and flows in the line by conversation with the interceptions;
the line module comprises all steps from the generation of the file to filing, each step related to a key; and
the organization module comprises all the interceptions with the keys.

2. A software development system for a framework, comprising
a database;
interfaces; and
procedures;
wherein
the database comprises a file table, an organization table, and an unlocking table;
the interfaces comprise a system login form, a main form, a child form of an interception, a file child form, an unlocking form, and sub-task and keys on the child form; and
the database is connected to the interfaces via the procedures.

3. The software development system of claim 2, wherein
the file table operates to build a plan file, to identify operation status of key procedures via recorded status thereof whereby functioning as a switch to activate an interception, and to build a file number as a key field, the key field comprising a step name, a plan time for the step, and a record time for the step, the plan time and the record time are parallel to each other and forms a loop; each time a new file is built, the circulation of the key field is used to control the implementation of tasks;
the organization table uses an organization number as a key field and collects organizations sharing different key procedures of the file table into the table, and the organization table authorizes a user to enter different child forms; and
the file unlocking table uses a record number as a key field, whereby managing locking and unlocking of files; each authorized unlocking department obtains and processes the record to be unlocked according to keyword selection pertained thereto.

4. The software development system of claim 2, wherein the system login form operates to authenticate a user, and to determine a department to which the user pertains whereby loading him to different child forms and enabling him to process different content therein.

5. The software development system of claim 2, wherein the main form has a style of multiple document interface, with capacity of loading child forms, searching files, and comprising shift keys.

6. The software development system of claim 2, wherein the child form is distributed and designed according to departments, each department having a child form called interception and each interception having keys for fields of steps; whether the contents of interception saved or not is decided by the status of the fields.

7. The software development system of claim 2, wherein the unlocking form shows the applying record and operates to unlock a file.

8. The software development system of claim 2, wherein the file child form operates to manage all files and status thereof, and to implement a fast inquiry of a file, control of file status, comprising unlocking and locking thereof, and reading of file content whereby creating, tracking and controlling the file, a file table being a table or a Gantt chart.

9. The software development system of claim 2, wherein the sub-task area is disposed under each of the child form, displaying the status of files needing to process.

10. The software development system of claim 2, wherein said process unit comprises:
1) a login procedure, operating to implement login of different users from different departments;
2) a procedure of switching interceptions under a main form, operating to implement switching between different keys and response to data export;
3) a procedure of searching files and reading under a main form, operating to implement data-reading procedures corresponding to different child forms;
4) a content inquiry procedure under a main form, operating to implement file retrieval for different keywords;
5) a file creation procedure under a file child form, operating to create a new file, and to make a new organization plan;
6) a file unlocking procedure under a file child form, operating to unlock a key procedure as the key procedure is locked;
7) a file freezing procedure under a file child form, operating to freeze a file as the file needs to be frozen;
8) a control key submission procedure under a child form, operating to implement locking of the key procedure via submission of the control key; and
9) an unlocking procedure, operating to lock a file via an authorized department having unlocking permission.

11. The software development system of claim 10, wherein the login procedure comprises:
1) searching for a login user, a password, and a workgroup in the organization table,
2) exiting if no result is found, and
3) opening the interception module of the workgroup if a result found.

12. The software development system of claim 10, wherein the interception switching procedure comprises:
1) searching for a file in the file table,
2) determining content to be read from a database according to requirement of form content of the interception module,
3) determining an activated interception module according to the interception switching procedure under the main form,
4) determining whether the procedure is completed according to a field value of a key procedure in the file table,
5) deactivating a corresponding key if the procedure is completed, or activating the corresponding key if the procedure is not completed.

13. The software development system of claim 10, wherein the content inquiry procedure of the child form under the main form comprises:
1) searching for a corresponding key field in the file table, and
2) displaying content of a file in the interception module of the file.

14. The software development system of claim 10, wherein the unlocking procedure comprises:
1) finding an unlocking record that has been processed,
2) finding a file number and a value for a key procedure according to content of the unlocking record, and
3) processing the file table, whereby finding a file number and a field for a key procedure, and performing value recovery thereon.
